(19) United States
(12) Patent Application Publication
(10) Pub. No.: US 2005/0106744 A1
(43) Pub. Date: May 19, 2005

(54) Optical analysis for heterogeneous medium

(76) Inventors: Yoshihiko Mizushima, Hamamatsu-shi (JP); Kazuji Matsumoto, Hamamatsu-shi (JP)

Correspondence Address: MORGAN LEWIS & BOCKIUS LLP, 1111 PENNSYLVANIA AVENUE NW, WASHINGTON, DC, 20004, US

(21) Appl. No.: 10/500,239

(22) PCT Filed: Dec. 26, 2002
(86) PCT No.: PCT/JP02/13716

(30) Foreign Application Priority Data
Dec. 26, 2001 (JP) 2001-395145

(51) Int. Cl. G01N 21/00

(52) U.S. Cl. 436/164

(57) ABSTRACT

This optical analysis method comprises a first step of making light having a known intensity I₀ at a known wavelength incident on a medium; a second step of measuring an optical intensity upon reflection or optical intensity upon transmission emitted from the medium; a third step of executing the first and second steps at a plurality of wavelengths and recording the optical intensity as a measurement result; and a fourth step of calculating a target physical quantity by a predetermined arithmetic operation utilizing a known physical quantity stored in a database and the optical intensity.

### TECHNICAL FIELD

The present invention relates to a method of optically analyzing an inhomogeneous medium.

### BACKGROUND ART

While natural products, organisms, etc. typify inhomogeneous scattering media, techniques for analyzing such a scattering medium which scatters light while having a nonuniform structure have not been known well. Of course, in homogeneous media can approximately be analyzed as a uniform subject, though.

According to Japanese Patent Application Laid-Open No. HEI 2-234048, an apparatus has been developed, which irradiates an organism with high-frequency pulse light (on the order of 70 MHz to 200 MHz) having several discrete wavelengths (e.g., 760 nm, etc.), receives the light at a certain distance, determines absorption and scattering coefficients at a measurement wavelength by using a diffusion equation with respective amounts of the attenuation, phase deviation, and modulation of the light, and estimates the amount of hemoglobin from the absorption coefficient.

### DISCLOSURE OF THE INVENTION

However, in an actual scattering medium, optical characteristics and refractive indexes may vary among its tissues, thereby causing mutual scattering among the tissues. Namely, biological tissues are not uniform, and cannot be obtained by simply mixing scatterers and absorbers uniformly. In an organic tissue, its characteristic substances (blood vessels, muscles, fats, etc.) are distributed in a complicated fashion, so that optical characteristics (e.g., transmittance distribution) of the organism differ from those of its ideal uniform system. However, the conventional method calculates the optical characteristics while assuming the organism to be a uniform system, and thus is hard to measure concentrations of substances in the organism accurately.

More specifically, the conventional theory cannot describe behaviors of light in a medium when optical characteristics vary among individual tissues so that mutual scattering occurs among the tissues. When the refractive index of the medium varies, its light velocity varies as well, whereby an analyzing method assuming that light propagates at a fixed speed does not hold. Analyses such as microscopic Monte Carlo method are not commonly applicable, since they cannot be conducted unless a nonuniform structure distribution is assumed with precision. Therefore, such a conventional method cannot analyze physical properties accurately.

Japanese Patent Application Laid-Open No. HEI 4-297854 discloses a physical quantity analyzing technique using an exponential function, which corrects light-diffusing effects in media. This method uses the exponential function as an absorbance correcting function, whereby effective optical path length increases because of light diffusion even in a uniform medium. Optical intensity attenuates when the effective optical path length increases.

Therefore, the physical quantity analysis of Japanese Patent Application Laid-Open No. HEI 4-297854 empirically introduces an exponential function having a constant with an unclear physical content in order to modify the apparent optical intensity when correcting influences of changes in absorbance.

For overcoming such a problem, it is an object of the present invention to provide a chemical analysis method which can accurately analyze inhomogeneous media.

The inventor of the present application has studied, as a method of chemically analyzing an inhomogeneous medium, an analysis method which expresses behaviors of light in two tissues (x, y) with respect to a light advancing direction when setting up an initial differential equation concerning an inhomogeneous model. Such an analysis method is theorized according to an increase in scattering fed from another channel, while being based on the attenuation of light caused by absorbent substances and scattering substances.

This differential equation and a conventional differential equation (e.g., Kubelka-Munk) basically differ from each other in their setup, so that the absorption and scattering coefficients in a general expression obtained by the foregoing usually differ from those in a theory used in general. It is therefore difficult for such a technique to evaluate results obtained by directly using a general expression in comparison with those obtained by the conventional method.

The method of the present invention conforms to a Kubelka-Munk type analysis method, and is based on an equation with respect to a light advancing direction, two simultaneous equations with respect to an opposite direction, and a general expression solving a differential equation describing the giving and taking of photons between two phases (x, y).

Therefore, when the part of mutual giving and taking of photons between the phases concerning nonuniformity is eliminated, a conventional Amy expression (Kubelka-Munk type general expression) is obtained, whereby the effectiveness of this nonuniformity theory can be proved more easily than the conventional method, and the most common solving method is yielded.

Characteristic features of the present invention lie in that a general expression explaining nonuniformity is determined, and that the general expression can determine an absolute value in a target tissue even when a medium itself has a complicated nonuniform area in which tissues are intertwined.

### BEST MODES FOR CARRYING OUT THE INVENTION

In the following, the method of chemically analyzing a inhomogeneous medium in accordance with an embodiment will be explained. Constituents identical to each other will be referred to with numerals or letters identical to each other without repeating their overlapping explanations.

In this method, a solution of simultaneous equations describing a state receiving optical scattering between a plurality of tissues is given in a function form in a method of chemically analyzing an inhomogeneous medium, which makes light incident on the inhomogeneous medium, detects the intensity of light emitted therefrom, inputs thus detected optical intensity into a predetermined function, and determines the physical quantity of the inhomogeneous medium. An undepicted arithmetic unit calculates a specific physical quantity by inputting the detected optical intensity and a known coefficient in a database into the function.

This function is defined by absorption coefficients (a) and scattering coefficients (s) of respective media of the tissues. Though this function also includes a tissue cross-sectional area ratio (K) and a mutual scattering coefficient (F) which are characteristics of nonuniformity, they are not required to have explicitly been known, which is a characteristic feature of this is method.

In a specific example in which a medium is composed of two kinds of tissues (X, Y), physical quantities concerning them are distinguished by suffixes (x, y). Namely, suffixes x and y indicate that their absorption coefficients a and scattering coefficients s relate to the respective tissues X and Y. The numbers of photons traveling the tissues X and Y are represented by x and y. The light entering direction is defined as Z direction. Since the photons are also converted into an opposite flow by scattering during their progress, those traveling forward and backward are provided with suffixes f and b, respectively. The numbers of photons traveling forward are x_{f} and y_{f}, whereas the numbers of photons traveling backward are x_{b} and y_{b}.

Basic equations are given by the following:

Behavior of light concerning the first tissue X:

$$\begin{matrix}\frac{ⅆ {x}_{f}}{ⅆ z} = - ( 1 - F ) ( {a}_{x} + {s}_{x} ) {x}_{f} + ( 1 - F ) {s}_{x} {x}_{b} + \frac{1}{2} {Fs}_{y} {y}_{f} + \\ \frac{1}{2} {Fs}_{y} {y}_{b} \\ - \frac{ⅆ {x}_{b}}{ⅆ z} = ( 1 - F ) {s}_{x} {x}_{f} - ( 1 - F ) ( {a}_{x} + {s}_{x} ) {x}_{b} + \frac{1}{2} {Fs}_{y} {y}_{f} + \\ \frac{1}{2} {Fs}_{y} {y}_{b}\end{matrix}$$

Behavior of light concerning the second tissue Y:

$$\begin{matrix}\frac{ⅆ {y}_{f}}{ⅆ z} = \frac{1}{2} {Fs}_{x} {x}_{f} + \frac{1}{2} {Fs}_{x} {x}_{b} - ( 1 - F ) ( {a}_{y} + {s}_{y} ) {y}_{f} + \\ ( 1 - F ) {s}_{y} {y}_{b} \\ - \frac{ⅆ {y}_{b}}{ⅆ z} = \frac{1}{2} {Fs}_{x} {x}_{f} + \frac{1}{2} {Fs}_{x} {x}_{b} + ( 1 - F ) {s}_{y} {y}_{f} \_ \\ ( 1 - F ) ( {a}_{y} + {s}_{y} ) {y}_{b}\end{matrix}$$

The coefficient determinant for expressing these differential equations is composed of four rows by four columns. If there are three kinds of tissues, expressions are made in conformity thereto, so as to form a coefficient determinant of six rows by six columns by using three kinds of optical coefficients and three mutual light quantity redistribution coefficients. These expanding methods have been known.

The above expressions are employed when the average radius of curvature r of a tissue interface is greater than the photon mean free path l, i.e., when r>l. When r<l, the above-mentioned Fsₓ or Fs_{y} is simply replaced by F.

When the above-mentioned differential equations are solved, transmittance (T) and reflectance (R) are given by the following expressions:

$$T = \frac{\frac{K σ}{1 + {σ}_{x}} exp ( - {λ}_{x} h ) + \frac{σ}{1 + {σ}_{y}} exp ( - {λ}_{y} h )}{\begin{matrix}\frac{K}{1 + {σ}_{x}} [ {( 1 + {σ}_{x} )}^{2} - {( 1 - {σ}_{x} )}^{2} exp ( - 2 {λ}_{x} h ) ] + \\ \frac{1}{1 + {σ}_{y}} [ {( 1 + {σ}_{y} )}^{2} - {( 1 - {σ}_{y} )}^{2} exp ( - 2 {λ}_{y} h ) ]\end{matrix}}$$

$$R = \frac{K ( 1 - {σ}_{x} ) [ 1 - exp ( - 2 {λ}_{x} h ) ] + ( 1 - {σ}_{y} ) ⌊ 1 - exp ( 2 - {λ}_{y} h ) ⌋}{\begin{matrix}\frac{K}{1 + {σ}_{x}} [ {( 1 + {σ}_{x} )}^{2} - {( 1 - {σ}_{x} )}^{2} exp ( - 2 {λ}_{x} h ) ] + \\ \frac{1}{1 + {σ}_{y}} [ {( 1 + {σ}_{y} )}^{2} - {( 1 - {σ}_{y} )}^{2} exp ( 2 {λ}_{y} h ) ]\end{matrix}}$$

where λₓ, λ_{y}, ρₓ, ρ_{y}, σₓ, and σ_{y} are as follows:

Since the depth (h) is longer than the photon mean free path length, the above-mentioned expressions are simplified as follows:

$$T = 4 \frac{K \frac{{σ}_{x}}{1 + {σ}_{x}} exp ( - {λ}_{x} h ) + \frac{{σ}_{y}}{1 + {σ}_{y}} exp ( - {λ}_{x} h )}{K ( 1 + {σ}_{x} ) + ( 1 + {σ}_{y} )}$$

$$R = \frac{K ( 1 - {σ}_{x} ) + ( 1 - {σ}_{y} )}{K ( 1 + {σ}_{x} ) + ( 1 + {σ}_{y} )}$$

$$λ = \sqrt{\frac{1 - F}{2} [ \begin{matrix}( 1 - F ) ( {ρ}_{x}^{2} + {ρ}_{y}^{2} ) \pm \\ \sqrt{{( 1 - F )}^{2} {( {ρ}_{x}^{2} - {ρ}_{y}^{2} )}^{2} + 4 {F}^{2} {s}_{x} {s}_{y} ( {a}_{x} + 2 {s}_{x} ) ( {a}_{y} + 2 {s}_{y} )}\end{matrix} ]}$$

Its two solutions are defined as λₓ and λ_{y}.

When
(ρₓ²−ρ_{y}²)²>4F²sₓs_{y}(aₓ+2sₓ)(a_{y}+2s_{y}),
the following expressions are effective by an approximation.

Therefore, the present invention also encompasses the case where the following expressions are used.

$$\begin{matrix}{λ}_{x} = \sqrt{{( 1 - F )}^{2} {ρ}_{x}^{2} \pm \frac{{F}^{2} {s}_{x} {s}_{y} ( {a}_{x} + 2 {s}_{x} ) ( {a}_{y} + 2 {s}_{y} )}{\vert {ρ}_{x}^{2} - {ρ}_{y}^{2} \vert}} \\ {ρ}_{x} = \sqrt{{a}_{x} ( {a}_{x} + 2 {s}_{x} )} \\ {λ}_{y} = \sqrt{{( 1 - F )}^{2} {ρ}_{y}^{2} \pm \frac{{F}^{2} {s}_{x} {s}_{y} ( {a}_{x} + 2 {s}_{x} ) ( {a}_{y} + 2 {s}_{y} )}{\vert {ρ}_{x}^{2} - {ρ}_{y}^{2} \vert}} \\ {ρ}_{y} = \sqrt{{a}_{y} ( {a}_{y} + 2 {s}_{y} )} \\ {σ}_{x} = \frac{{λ}_{x}}{{a}_{x} + 2 {s}_{x}} \\ {σ}_{y} = \frac{{λ}_{y}}{{a}_{y} + 2 {s}_{y}}\end{matrix}$$

As mentioned above, F²sₓs_{y} is simply replaced by F² when r<l here as well. K is the cross-sectional area ratio of X and Y tissues, whereas F is the mutual scattering light exchange coefficient between tissues (light quantity redistribution coefficient by mutual scattering between X and Y tissues). None of them is required to be given explicitly as a value as will be explained later.

If all of a, s, K, and F for the tissues are known, T and R can be determined. In a measurement analysis, on the other hand, necessary values among a, s, K, and F can be determined if values of T and R are measured. Namely, since reflected light intensity I_{(R)}=I₀×R or transmitted light intensity I_{(T)}=I₀×T can be measured, each of them becomes an expression with a, s, K, and F alone if incident light intensity I₀ at a known wavelength is known. If K and F are known as coefficients, for example, two simultaneous equations including unknowns a and s can be obtained. Unknown coefficients, i.e., target physical quantities, can be calculated if the known coefficients are stored in a database and measured values are put into the above-mentioned functions in the arithmetic unit together with the known coefficients.

In this case, the unknowns can be determined if equations whose number is not smaller than that of the unknowns are set up. While it has conventionally been impossible to calculate concentrations of ingredients from measured results in the case of inhomogeneous media, this method makes it possible to calculate accurate ingredient concentrations for the first time.

F will now be explained. In general, in order for photons scattered within tissues on both sides of an interface therebetween to enter their neighboring tissues beyond the interface, their scattering points must exist within the photon mean free path from the interface. The volume concerned exists within the mean free path from the interface.

As the scattering coefficient is higher, the quantity of light mingling into the neighboring tissue upon scattering increases. On the other hand, the mean free path becomes shorter, whereby the total volume of related generation points decreases. The increase and decrease cancel each other out, so that quantities of light mingling from neighboring tissues are equal to each other and are constant regardless of the scattering coefficient.

This can be proved by mathematical calculations as well.

Though the above relates to a case where the interface between tissues is a plane, a case where the interface between tissues is a curved surface will be considered separately therefrom. Here, it is assumed that one of the tissues has a curved surface such as that of a capillary in an organism, while its average radius of curvature is shorter than the photon mean free pathon the contrary to the above.

The light scattered in a blood vessel always exits to an external tissue, so that its related generation volume is the blood vessel volume itself. On the other hand, generation points of photons which are scattered in tissues on the outside of the blood vessel and mingle into the blood vessel only exist on the outer surface of a cylinder surrounding the blood vessel while having a radius therefrom equal to the mean free path.

The product of the related volume and the solid angle by which scattered light diverging therefrom just reaches the inside of the blood vessel becomes an effective volume for exchanging photons. When calculated, this volume can be proved to be substantially equal to the original blood vessel volume.

As explained in the foregoing, the above-mentioned differential equations are based on the inventor's finding that the mutual mingling coefficient of light between inhomogeneous media is simplified and can be considered constant. However, the equations explained in the foregoing relate to a case where the radius of curvature of the interface is shorter than the mean free path. When the radius of curvature of the interface is longer, by contrast, an expression in which F²sₓs_{y} in the above-mentioned equation is simply replaced by another constant F² is used. It will be sufficient if these equations are selectively used depending on the object.

The tissue cross-sectional area ratio K is originally a geometric constant and can be considered an undetermined constant.

However, there may be a case where the ratio is not constant in the light penetrating direction z in a medium to be measured.

In such a case, the tissue cross-sectional area ratio K is treated as an average constant concerning the depth of the medium. When K changes moderately with respect to the depth, this change can be neglected.

The number of equations can be increased by changing measurement wavelengths. Of course, the wavelength dependence of each of coefficients in each case is required to be known.

The foregoing technique can determine the optical absorption coefficient a, vertical scattering coefficient s, etc.

In general, physical quantities to be determined by a measurement analysis are ingredient concentrations and the like. Here, if two ingredients (p, q) exist in both of the tissues X and Y, the absorption coefficient a and scattering coefficient p are given by the following expressions (*):
(*)
   aₓ=(aₓ/pₓ)pₓ+(aₓ/qₓ)qₓ
   sₓ=(sₓ/pₓ)pₓ+(sₓ/qₓ)qₓ
   a_{y}=(a_{y}/p_{y})p_{y}+(a_{y}/q_{y})q_{y}
   s_{y}=(s_{y}/p_{y})p_{y}+(s_{y}/q_{y})q_{y}

Since a/p, a/q, s/p, s/q, and the like are absorption or scattering coefficients per unit concentration of their corresponding target ingredients (in the medium) and are known in general, p and q can be determined by an algebraic calculation from a and s determined as above.

Since constants can be erased later, the measurement background noise (constant) may be incorporated in addition to the above-mentioned p and q proportional terms when necessary.

These equations are based on the proportional addition rule of the most common concentration media.

In practice, scattering coefficients are likely to change in high concentration media because of multiple scattering or association of scattered particles and the like, so that the proportionality may be lost.

When multiple scattering occurs, the total scattering tends to be saturated. At this time, a proportionality such as that of the following equation, which is weaker than the linear proportionality, is employed, for example. Which proportionality to employ is determined beforehand by a study depending on the object.

$$S = {S}_{0} {p}^{1 / n} or S = \frac{{S}_{0}}{1 - p}$$

Meanwhile, the above-mentioned expressions include unknown coefficients (K, F). These coefficients are known to be constants and thus can be erased easily. It will be sufficient if measurement is performed with varied wavelengths in order to set up an additional number of equations corresponding to the number of unknown coefficients.

In general, however, there is a high risk of increasing errors if the minimal number of equations are set up while relying on the wavelength dependence alone. This is because errors often exist in various coefficients themselves and accumulate in final results. It is therefore important to carry out measurement in many wavelengths other than those minimally employed, in order to alleviate the errors. In this case, arithmetic operations are performed according to the method of least squares.

When determination equations are nonlinear as in the present invention, least-squares calculations of nonlinear equations are carried out according to Newton's approximation. Here, when arithmetic operations are complicated as in the present invention, calculations in which the least-squares method is applied to individual stages for respective equations mentioned above seem to be easier for determining final p and q.

When calculations are employed in a divided fashion as such, the convergence of errors, which is a characteristic feature of the least-squares method, is divided into the respective stages, whereby there is no guarantee that an optimal value is finally obtained.

In this regard, since all the stages are expressed by analytical expressions though nonlinear, the present invention can analytically express the coefficient matrix of the determinant in each stage and can attain the total solution by simply applying the least-squares method to the final single determinant, while being able to derive coefficient determinants from the individual stages and combine them together, which are excellent features. In the following, an example of solving method will be set forth.

Since Newton's approximation is well known, only its fundamental means will be explained in brief. When (e.g., 16) values measured with respective wavelengths different from each other of deviations from an estimated resolution value taken as a center are referred to as m1, . . . , m16, they are represented as in the following equation since T and R are described by p and q. [M] is a Jacobian determinant according to differential classes of the individual coefficients and is a known coefficient.

$$[ \begin{matrix}Δ {m}_{1} \\ ⋮ \\ Δ {m}_{16}\end{matrix} ] = [ M ] [ \begin{matrix}Δ {a}_{x} \\ Δ {a}_{y} \\ Δ {s}_{x} \\ Δ {s}_{y} \\ Δ K \\ Δ F\end{matrix} ]$$

[M] is diagonalized when necessary.

Subsequently, matrix [A] is determined by the above-mentioned expression (*), whereas a and s are described by p and q, whereby the following equation is obtained similarly:

$$[ \begin{matrix}Δ {a}_{x} \\ Δ {a}_{y} \\ Δ {s}_{x} \\ Δ {s}_{y} \\ Δ K \\ Δ F\end{matrix} ] = [ A ] [ \begin{matrix}Δ {p}_{x} \\ Δ {q}_{y} \\ Δ {p}_{x} \\ Δ {q}_{y} \\ Δ K \\ Δ F\end{matrix} ]$$

Hence, the solution of the following equation can be obtained:

$$[ \begin{matrix}Δ {p}_{x} \\ Δ {q}_{y} \\ Δ {p}_{x} \\ Δ {q}_{y} \\ Δ K \\ Δ F\end{matrix} ] = {{[ A ]}^{- 1} [ M ]}^{- 1} [ \begin{matrix}Δ {m}_{1} \\ ⋮ \\ Δ {m}_{16}\end{matrix} ]$$

In these numeric calculations, accelerated convergence solving techniques can be employed by various known methods. In the case of the above-mentioned example, calculations are possible with any number of wavelengths (e.g., 4096 wavelengths) not smaller than 6, regardless of whether they have a continuous spectrum or discrete wavelength characteristics. If a sufficient number of measurement operations are carried out with respective wavelengths different from each other, final calculation results can be obtained with the least error, which has conventionally been impossible in such a complicated system.

In particular, there has conventionally been no theory which enables numeric calculations by such an analytic technique. It is a new discovery that the interrelationship between nonuniform minute tissues can be expressed and processed by simple coefficients of K and F.

If it is clear that the medium has totally different layer structures in its depth, e.g., where a skin layer, a coating protecting layer, and the like exist, they are preferably divided for respective calculations. The calculations are simple when the partial thickness of each layer is known, but can also attain solutions when the thickness is unknown. Namely, the coefficient matrices explained above can be combined together, so as to be treated as a cascade of two kinds of transfer functions.

It is indicated that calculations should include some undetermined coefficients in the case explained in the foregoing. It is shown that complicated tissue structures in inhomogeneous media and the like can be expressed as a form including unknown coefficients by setting up a number of simultaneous equations and solving them by employing the least-squares method. A characteristic feature of this theory also lies in that solutions can thus be determined while utilizing the fact that unknown coefficients can be erased as implicit functions.

Therefore, metrical solutions can be determined even when a tissue has a nonuniform structure and a complicated, unknown, intricate form or an unknown cross-sectional area.

This immediately guarantees quantitative measurement results of p, q, and the like. For example, though conventional biological optical analyses can easily detect the absorption of oxygenated hemoglobin in the blood, they cannot determine an absolute ingredient amount quantitatively but measure only qualitative behaviors if the effective cross-sectional area ratio of the blood vessel is unknown. By contrast, the method of the present invention makes it possible to erase the effective cross-sectional area and the like and determine the absolute value of a specific ingredient in a specific tissue for the first time.

Thus not only actual objects, organisms, and the like are nonuniform, but also their tissues are complicated and have conventionally been impossible to display and analyze mathematically. The technique of the present invention has found that tissue structure parameters can be approximated as simple implicit functions, and erases them in the process of a numeric analysis, thus exhibiting a characteristic feature of being able to reach solutions without arguing nonuniform contents in detail.

When a substance is a medium having a nonuniform structure or a multiphase or multiphase separation structure as in a mixture, the above-mentioned method can be applied thereto, so as to separate individual components in each tissue from each other and calculate them independently from each other. When the in homogeneous medium is composed of a number of sectional tissues, simultaneous equations including the number of intermediate elements corresponding to the kinds of tissues can be contracted, and thus contracted equations can be applied to the above-mentioned analyzing technique in the case where the number of tissues X, Y is 2.

The analyzing method explained here is quite useful in practice, since target solutions can be attained without explicitly handling differences in detailed optical characteristics among a plurality of tissues composed of tissues X, Y, etc. In a measurement example in an organism as a specific example, blood vessels and other tissues exist as an inhomogeneous multiphase mixture state in an actual organism. According to the example mentioned above, the X tissue is treated as the blood part in the blood vessels, the Y tissue is treated as the other tissue part, and x and y are calculated as respective quantities of light included therein.

Measurement of concentrations of oxygenated hemoglobin and reduced hemoglobin in the X tissue, measurement of concentrations of protein groups (Cytochrome, aa3, etc.) of electron transport systems in Y tissue cells, etc. become possible.

Such characteristic features make the present invention effectively applicable to media which are mixed nonuniformly with absorption and scattering coexisting, and a wide range of substances conventionally hard to measure, thus yielding great effects. Examples of the substances include industrial products, natural products such as food and plants, other mixtures, polycrystals, and turbid materials.

In brief, the present invention is effective when substances having respective modes different from each other are mixed nonuniformly.

As for foods, while cereals, fruits, oils and fats, etc. are vigorously studied and developed in terms of quantitative measurement of inner substances and the like by utilizing infrared light, analyses are in progress while their samples are considered uniform. However, foods include those which should clearly be treated as nonuniform substances, such as a product in which cut fruits are contained in a yogurt. The method of the present invention works effectively for them.

In the field of color matching of fiber dying (color matching calculations), the method of the present invention is not effective in the field of color matching calculations for a scheme in which fabrics are dyed after being prepared, but in the field of so-called fiber blend color matching calculations in which strings or wool yarns are dyed beforehand and then these strings having respective colors slightly different from each other are mixed or strings having respective colors different from each other are mixed so as to yield a desirable color.

In the field of water, plastics, and other (metal) materials (while assuming visible light to be a common electromagnetic wave instead of medium), a solid, a liquid, or their transient state (solid solution in the case of a metal) exists in their melted stage. The present invention can become means for elucidating details of their mixed state.

Also, the mathematical theory solely extracted from this specification is seen to be effective in the study and elucidation of nonuniform and inhomogeneous systems in future. This is because the science of nonuniform systems has just begun at present, so that substantially no theoretical expression for explaining a nonuniform system exists except for that of the present invention.

For example, when a developing process in which an ovum grows to a human by way of an embryo is optically studied, nonuniformity increases.

The present invention can become one of mathematical theories which gives a hint to a grand problem of why an organism makes a nonuniform system and complex system so skillfully and perfectly, and an experimental system therefor in future.

However, it is necessary that (i) a numerical database of absorption and scattering coefficients be known and that (ii) the convenience of numerical processing be studied since the method is based on a generic solution, whereby the amount of calculations can increase. These may vary depending on objects, whereby it is necessary to find appropriate simplifying means empirically for specific cases.

While it is stated that the parameters of the tissues can be approximated as simple implicit functions and erased in the process of numerical analysis, it is one of points in practice how calculations are carried out without letting out the tissue parameters. The above-mentioned arithmetic operations are performed by a computer as an arithmetic unit.

The expression on which the above-mentioned general expressions are based is an expression of Amy (L. Amy, Rev. d'optique 16 81 (1938)). The general expressions of the present invention are based on Amy's expression (uniform composition expression for a single composition) and developed into an on uniform state, i.e., giving and taking of photons between different channels are added thereto. Thus designed expressions can be used as general expressions for quantitatively analyzing substances in mixtures, polycrystals, turbid materials, and other nonuniform states.

As explained in the foregoing, the method of optically analyzing an inhomogeneous medium in accordance with the above-mentioned embodiment determines a physical quantity of a light-absorbing and light-scattering inhomogeneous medium including a plurality of tissues X, Y having respective optical characteristics different from each other from the intensity of light transmitted there through or reflected thereby. A procedure executed by a computer comprises the following steps:

(i) Light having a known intensity I₀ at a known wavelength is made incident on the medium from a light source.

(ii) The optical intensity I_{(R)} upon reflection or optical intensity I(T) upon transmission emitted from the medium is measured by a photodetector.

(iii) The above-mentioned steps (i) and (ii) are executed at a plurality of wavelengths, and the optical intensity I_{(R)} or I_{(T)} as a measured result is recorded into a storage device of the computer.

(iv) Using a known physical quantity (PV) and the optical intensity I_{(R)} or I_{(T)} recorded in the storage device, a target physical quantity is calculated by an arithmetic operation of the computer. The tissues are composed of two phases of X and Y, whereas the target physical quantity is set to a physical quantity other than the known physical quantity (PV) in the database.

Namely, the target physical quantity is determined by inputting those known in the following coefficients as known physical quantities stored in the data base and the measured optical intensity I_{(R)} or I_{(T)} into those related to the arithmetic operation in the following expressions:
(1) detected value I_{(R)} or I_{(T)}
(2) physical quantities in the database
T: transmittance of the medium
R: reflectance of the medium
h: thickness of the medium
aₓ: absorption coefficient of tissue X
sₓ: scattering coefficient of tissue X
a_{y}: absorption coefficient of tissue Y
s_{y}: scattering coefficient of tissue Y
ρₓ: parameter defined for tissue X in conformity to a uniform system
ρ_{y}: parameter defined for tissue Y in conformity to a uniform system
σₓ: parameter defined for tissue X in conformity to a uniform system
σ_{y}: parameter defined for tissue Y in conformity to a uniform system
K: cross-sectional area ratio of tissues X and Y
F: light quantity redistribution coefficient of mutual scattering between tissues X and Y
λₓ, λ_{y}: two solutions of λ equation.

Here, each of (aₓ, sₓ) and (a_{y}, s_{y}) has conventionally been written as (μₐ, μₛ′) in academic literatures.

(3) Expressions
reflected light intensity I(R)=I₀×R
transmitted light intensity I(T)=I₀×T

$$R = \frac{K ( 1 - {σ}_{x} ) + ( 1 - {σ}_{y} )}{K ( 1 + {σ}_{x} ) + ( 1 + {σ}_{y} )}$$

$$T = 4 \frac{K \frac{{σ}_{x}}{1 + {σ}_{x}} exp ( - {λ}_{x} h ) + \frac{{σ}_{y}}{1 + {σ}_{y}} exp ( - {λ}_{x} h )}{K ( 1 + {σ}_{x} ) + ( 1 + {σ}_{y} )}$$

$$\begin{matrix}{σ}_{x} = \frac{{λ}_{x}}{{a}_{x} + 2 {s}_{x}} \\ {σ}_{y} = \frac{{λ}_{y}}{{a}_{y} + 2 {s}_{y}}\end{matrix}$$

$$λ = \sqrt{\frac{1 - F}{2} [ \begin{matrix}( 1 - F ) ( {ρ}_{x}^{2} + {ρ}_{y}^{2} ) \pm \\ \sqrt{{( 1 - F )}^{2} {( {ρ}_{x}^{2} - {ρ}_{y}^{2} )}^{2} + 4 {F}^{2} {s}_{x} {s}_{y} ( {a}_{x} + 2 {s}_{x} ) ( {a}_{y} + 2 {s}_{y} )}\end{matrix} ]}$$

$${ρ}_{x} = \sqrt{{a}_{x} ( {a}_{x} + 2 {s}_{x} )}$$

$${ρ}_{y} = \sqrt{{a}_{y} ( {a}_{y} + 2 {s}_{y} )}$$

The mutual redistribution coefficient F is determined by fine structures of tissues and mostly is a constant. Namely, F in the above-mentioned expression is used when the average radius of curvature of the tissue interface is smaller than the photon mean free path, whereas another constant F₂ is simply used in place of F₂sₓs_{y} in the expression when the average radius of curvature is greater than the photon mean free path.

Using relationships in which the physical quantities ax, sₓ, a_{y}, and s_{y} are proportional to the concentration of a predetermined target ingredient in the medium, the concentration of the predetermined ingredient can be calculated.

When a nonproportional relationship due to multiple scattering or the like exists between the concentration of each ingredient and its absorption or scattering light quantity instead of a usual proportional relationship, solutions can be determined by employing their relational equation which is not linearly proportional.

The optical analysis method of the present invention can accurately analyze inhomogeneous media.

### Industrial Applicability

The present invention can be utilized in a method of optically analyzing inhomogeneous media.

1. A polyketone comprising repeating units, 95-100 mole % of which are 1-oxotrimethylene represented by formula (1) and having an intrinsic viscosity of 2.5-20 dl/g, wherein the content of Pd element is 0-20 ppm, terminal structures include an alkyl ester group (terminal group A) represented by the formula (2) and an alkyl ketone group (terminal group B) represented by formula (3), and the equivalent ratio of terminal group A/terminal group B is 0.1-8.0: 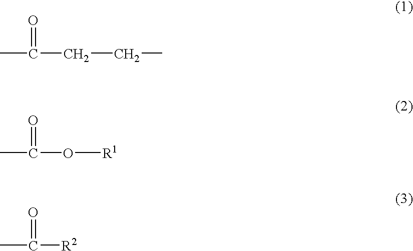
(wherein R¹ is hydrocarbon of 1-6 carbon atoms and R² is an organic group of 1-10 carbon atoms).

2. A polyketone according to claim 1, wherein the intrinsic viscosity is 4.0-8.0 dl/g, the equivalent ratio of terminal group A/terminal group B is 0.5-3.0, and the content of Pd element is 0-10 ppm.

3. A polyketone according to claim 1, wherein the content of carboxylic acid terminal group is 0-10 milli-equivalent/kg.

4. A polyketone according to claim 1 or 3, which has a DSC melting point Tm³ of 230° C. or higher.

5. A polyketone according to claim 1 or 3, which has a DSC melting point Tm³ of 240° C. or higher.

6. A polyketone according to claim 1 or 3, wherein the terminal group A is a methyl ester group represented by the following formula (4), the terminal group B is an ethyl ketone group represented by the following formula (5), and the equivalent ratio of terminal group A/terminal group B is 1.0-8.0:

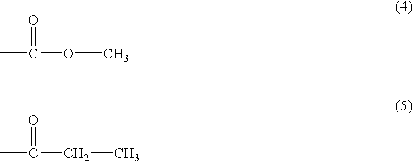

7. A polyketone according to claim 1 or 3, wherein the terminal group A is an isopropyl ester group represented by the formula (6), the terminal group B is an ethyl ketone group represented by the formula (5), and the equivalent ratio of terminal group A/terminal group B is 0.5-2.5:

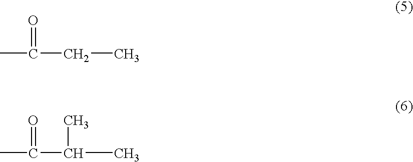

8. A polyketone according to claim 1 or 3, wherein when the polyketone is dissolved in hexafluoroisopropanol at a concentration of 0.1 wt % and ultraviolet spectrum of the solution is measured in a quarts cell at a scanning speed of 200 nm/min and a data intake interval of 0.5 nm, the minimum value of absorbance observed at a wavelength of 200-250 nm is 0.14 or less.

9. A polyketone molded product having repeating units, 95-100 mol % of which are 1-oxotrimethylene represented by the formula (1) and having an intrinsic viscosity of 2.5-20 dl/g, wherein the content of Pd element is 0-20 ppm and terminal structures include an alkyl ester group (terminal group A) represented by the formula (2) and an alkyl ketone group (terminal group B) represented by the formula (3), and the equivalent ratio of terminal group A/terminal group B is 0.1-8.0: 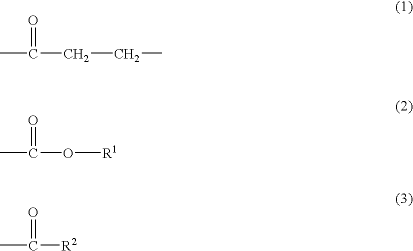
(wherein R¹ is hydrocarbon of 1-6 carbon atoms and R² is an organic group of 1-10 carbon atoms).

10. A polyketone fiber having repeating units, 95-100 mol % of which are 1-oxotrimethylene represented by the formula (1) and having an intrinsic viscosity of 2.5-20 dl/g, wherein the content of Pd element is 0-20 ppm and the terminal structures include an alkyl ester group (terminal group A) represented by the formula (2) and an alkyl ketone group (terminal group B) represented by the formula (3), and the equivalent ratio of terminal group A/terminal group B is 0.1-8.0: 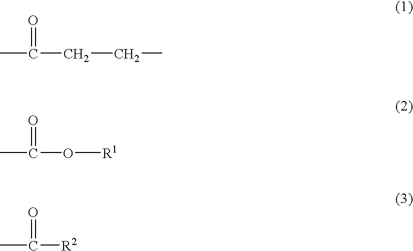
(wherein R¹ is hydrocarbon of 1-6 carbon atoms and R² is an organic group of 1-10 carbon atoms).

11. A tire cord comprising at least 50 wt % of the polyketone fiber according to claim 10.

12. A polyketone article, characterized in that the polyketone molded product according to claim 9 or the polyketone fiber according to claim 10 is at least partly used in the article.

13. A polyketone article according to claim 12 which is a tire, a belt or a constructional material.

14. A fiber-reinforced composite material comprising at least 1 wt % of the polyketone fiber according to claim 10 with respect to the whole fibers.

15. A method for producing a polyketone having an intrinsic viscosity of 2.5-20 dl/g by copolymerizing carbon monoxide and an ethylenically unsaturated compound, wherein the copolymerization is carried out in the presence of a metal complex catalyst obtained by reacting the following compounds (a)-(c), in the following liquid medium (d), and under the following conditions (e):
(a) a palladium compound,
(b) a bidentate ligand having an atom of Group 15 elements,
(c) an acid having a pKa of 4 or less,
(d) a liquid medium containing an alcohol of 1-6 carbon atoms and water and having a water content, as represented by the following Expression 1, of 10-500,000 ppm,
(e) a polymerization pressure P of 5 MPa or higher and a polymerization temperature T of 50-200° C.,
$$Water content ( ppm ) = \frac{Mass of water ( g )}{\begin{matrix}Volume of polymerization solvent other \\ than water ( ml ) + Volume of water ( ml )\end{matrix}} \times {10}^{6}$$
(the volumes in the denominator of the right side are values at 25° C.).

16. A method for producing a polyketone according to claim 15, wherein the polymerization temperature is 70-200° C. and the polymerization pressure is 7 MPa or higher.

17. A method for producing a polyketone according to claim 15 or 16, wherein (a) is at least one palladium compound selected from the group consisting of palladium acetate, palladium trifluoroacetate, palladium acetylacetonate and palladium chloride;
(b) is at least one phosphorus bidentate ligand selected from the group consisting of 1,3-bis{di(2-methoxyphenyl)phosphino}propane, 1,3-bis(diphenylphosphino)propane, 1,2-bis[{di(2-methoxyphenyl)phosphino}methyl]benzene and 1,3-bis{di (2-methoxy-4-sodium sulfonate-phenyl) phosphino}propane;
(c) is at least one acid selected from the group consisting of sulfuric acid, methanesulfonic acid, trifluoromethanesulfonic acid and trifluoroacetic acid; and
(d) is a solvent containing at least one alcohol selected from the group consisting of methanol, ethanol, n-propanol and isopropanol.

18. A method for producing a polyketone according to claim 15, wherein the copolymerization is carried out in the presence of benzoquinone or naphthoquinone.

19. A method for producing a polyketone according to claim 15, wherein the molar ratio of ethylenically unsaturated compound/carbon monoxide in the reaction vessel is 1/1-5/1.

20. A method for producing a polyketone according to claim 15, wherein the amount of the palladium compound used is 0.01-10,000 micromoles per 1 liter of the polymerization solvent, and the amount of the bidentate ligand having an atom of Group 15 elements and the amount of the acid having a pKa of 4 or less are 0.1-10 moles and 0.1-10,000 moles, respectively, based on 1 mole of the palladium compound.

21. A method for producing a polyketone according to claim 15, wherein the content of the alcohol of 1-6 carbon atoms in the liquid medium (d) is 75 vol % or more.

22. A method for producing a polyketone according to claim 15, wherein the acid having a pKa of 4 or less is sulfuric acid and the polymerization solvent contains an alcohol of 1-6 carbon atoms and water, the water content being 10-500,000 ppm.

23. A method for producing a polyketone according to claim 15, wherein the polymerization pressure P (MPa) and the polymerization temperature T (° C.) satisfy both of the following Expressions 2 and 3:
P≧720×exp(−0.0629×T) Expression 2
P≧0.0179×exp(0.0607×T). Expression 3

24. A method for producing a polyketone having an intrinsic viscosity of 3.0-20 dl/g by copolymerizing carbon monoxide and an ethylenically unsaturated compound, wherein the polymerization activity is 10 kg/g-Pd·hr or higher.

25. A method for producing a polyketone having an intrinsic viscosity of 2.5-20 dl/g by copolymerizing carbon monoxide and an ethylenically unsaturated compound, wherein the polymerization activity is 20 kg/g-Pd·hr or higher and the catalyst efficiency (kg/g-Pd) expressed by the product of the polymerization activity and the polymerization time (hr) is 50 or higher.
